(19) United States
(12) Patent Application Publication
(10) Pub. No.: US 2024/0371299 A1
(43) Pub. Date: Nov. 7, 2024

(54) Wind Release Light Pole Signs

(71) Applicant: Timothy Mark Baldwin, Tempe, AZ (US)

(72) Inventor: Timothy Mark Baldwin, Tempe, AZ (US)

(21) Appl. No.: 18/656,120

(22) Filed: May 6, 2024

Related U.S. Application Data
(63) Continuation-in-part of application No. 29/876,517, filed on May 23, 2023.
(60) Provisional application No. 63/500,209, filed on May 4, 2023.

(51) Int. Cl. G09F 7/22; G09F 7/18

(52) U.S. Cl. CPC G09F 7/22; G09F 2007/1808; G09F 2007/1847

(57) ABSTRACT

The light pole sign system is intended to provide users with sign system that is more durable, easier to install, and with wind release capability. To accomplish this, the device includes a lower signage holder, an upper signage holder, and a sign board. Each of the signage holders mount directly to a light pole with hose clamps and are spaced apart to fit the sign board in between. The device further incorporates swivel arms, which enable the sign board to pivot about an off-center pivot point. Springs are used to keep the sign board in its resting position. When the wind kicks up, the springs and off-center pivot point turn the sign board enough to release the wind pressure exerted on the sign and continue to do so until the pressure subsides. Once the wind subsides, the spring tension returns the sign board back to its original resting position.

### FIELD OF THE INVENTION

The present invention relates generally to a signage system. More specifically, the present invention is a light pole sign system with wind release capability. The sign system can be configured in multiple ways to display various types of signs.

### BACKGROUND OF THE INVENTION

Installing signs on light poles is a common practice used for both marketing and public awareness. These signs are intended to be seen by drivers passing by, as well as pedestrians walking near the sign. The primary product in the marketplace today is a pole pocket vinyl banner application mounted to the light pole with brackets and a rod. Although the design is relatively simple, there are several issues when using this product. Specifically, the banners are seldom taught, there is no wind release, high winds tear the banners, the banners act like parachutes increasing the wind pressure on the graphics, and the pole banner pole pockets tear. For round poles in particular, the hardware attaching the pole banner to the pole tends to spin around. Changing out the graphics can also be difficult. This involves releasing the bottom bracket connectors, changing the graphics, and pulling the banner down with some force to tighten and then secure the bottom bracket. There have been many instances where within a week of a new installation, a storm passes through and destroys over half of the pole banners. The service calls and complaints are very high.

Attempts have been made by others to resolve the problems described above. One such invention uses a spring near the light pole that allows for some wind release. However, this provides very little benefit. The banners are still not taught, they still rip frequently, difficult to change graphics, they still spin around the round poles, and the service calls are still high. Thus, a need exists to develop an effective light pole sign system capable of handling all types of weather conditions including high winds, sun, rain, and snow. There are other important challenges including different size light poles, different types of light poles (e.g., square, round, and tapered), installation, easily changing graphics, easily adding for temporary graphics, weight, durability, material choices (e.g., metals, plastic), and taught and readable graphics.

It is an objective of the present invention to provide a solution to the aforementioned problems. The present invention is a light pole sign system with wind release capability. As compared to other light pole sign systems, the present invention is easier to install and provides additional signage options to the customer. The present invention comprises a pair of signage holders (upper and lower) and a sign board. Each of the lower and upper signage holders mount directly to a light pole with hose clamps. The two signage holders are spaced apart to fit the sign board in between. Both the upper and lower signage holders incorporate swivel arms, which enable the sign board to pivot about an off-center pivot point. This provides two major benefits. First, when the wind is blowing directly into the sign, it divides the wind pressure causing the sign board to turn, thereby moving the wind pressure to the pivot point. If the pivot point were located at the middle, the sign board would bend or curve, which is why other pole banners have high failure rates. The second benefit for having an off-center pivot point is that it eliminates the tendency for the sign board to flutter in high winds. In particular, when a strong wind is coming directly at the outside leading edge of the sign at the rear (i.e., the edge closest to the light pole), the sign board has a tendency to flutter. Essentially, the sign board does not know what direction to move and eventually, the sign board pressure pushes the sign board sideways enough to lock in place and is prevented from returning to its normal position. This effect destroys the graphics, sign, banner and often the related hardware. By moving the pivot point so that the larger distance is on the rear side closest to the light pole, it allows the back side to act as a rudder to help move the front side of the sign board back to the center or resting position. Springs are used to keep the sign board in its resting position. When the wind kicks up, the springs and off-center pivot point are designed to turn the sign board enough to release the wind pressure exerted on the sign and continue to do so until the pressure subsides. Once the wind subsides, the spring tension returns the sign board back to its original resting position. Additionally, the present invention may be used for signs that can be secured in multiple ways to the sign board.

### SUMMARY OF THE INVENTION

It is an aim of the present invention to provide an improved light pole sign system that is more durable, easier to install, and provides additional signage options to the customer. The present invention is a light pole sign system with wind release capability. The present invention comprises a lower signage holder, an upper signage holder, and a sign board. Each of the lower and upper signage holders mount directly to a light pole with hose clamps and are spaced apart to fit the sign board in between.

Both the upper and lower signage holders incorporate swivel arms, which enable the sign board to pivot about an off-center pivot point. This provides two major benefits. First, when the wind is blowing directly into the sign, it divides the wind pressure causing the sign board to turn, thereby moving the wind pressure to the pivot point. Second, the off-center pivot point eliminates the tendency for the sign board to flutter in high winds. Springs are used to keep the sign board in its resting position. When the wind kicks up, the springs and off-center pivot point are designed to turn the sign board enough to release the wind pressure exerted on the sign and continue to do so until the pressure subsides. Once the wind subsides, the spring tension returns the sign board back to its original resting position.

With regard to signage options, the sign board can be configured in multiple ways, depending on customer requirements. One option is to use Velcro strips applied along all four sides of the sign, as well as three sides of the sign board. The sign is then wrapped around the sign board and secured by the Velcro strips. This process eliminates pockets of air getting behind the sign and potentially damaging them.

In another configuration, an optional solar-powered LED light can be installed near the top of the present invention. During the night, the LED lights provide sufficient lighting to both sides of the sign board.

### BRIEF DESCRIPTION OF THE DRAWINGS

FIG. 1 is a top-front perspective view of the present invention.

FIG. 2 is a front elevational view of the present invention.

FIG. 3 is a top plan view of the present invention.

FIG. 4 is a top-front perspective exploded view of the lower signage holder of the present invention.

FIG. 5 is a top-front perspective view of the lower signage holder of the present invention, shown assembled.

FIG. 6 is a bottom-front perspective exploded view of the upper signage holder of the present invention.

FIG. 7 is a bottom-front perspective view of the upper signage holder of the present invention, shown assembled.

FIG. 8 is a perspective view of the pole bracket of the present invention.

FIG. 9 is a top plan view of the pole bracket of the present invention.

FIG. 10 is a left-side elevational view of the pole bracket of the present invention.

FIG. 11 is a top-front perspective view of the pole arm of the present invention.

FIG. 12 is a front elevational view of the pole arm of the present invention.

FIG. 13 is a top-front perspective view of the lower swivel arm of the present invention.

FIG. 14 is a front elevational view of the upper swivel arm of the present invention.

FIG. 15 is a front elevational view of the sign board of the present invention, shown with a sign detached.

FIG. 16 is a is a top-front perspective view of the present invention, in accordance with another embodiment, wherein a plurality of illuminating devices is mounted onto the upper connecting member.

FIG. 17 is a top-front perspective view of the present invention, in accordance with another embodiment, wherein a plurality of mounting plates is attached to the pole arms.

### DETAIL DESCRIPTIONS OF THE INVENTION

All illustrations of the drawings are for the purpose of describing selected versions of the present invention and are not intended to limit the scope of the present invention.

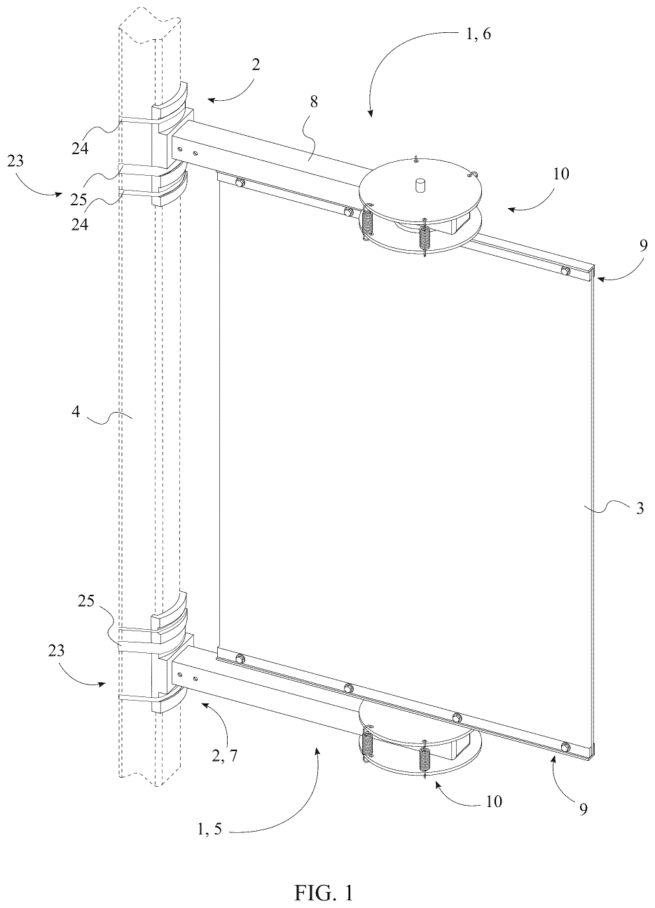

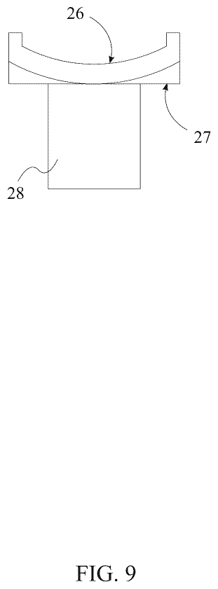

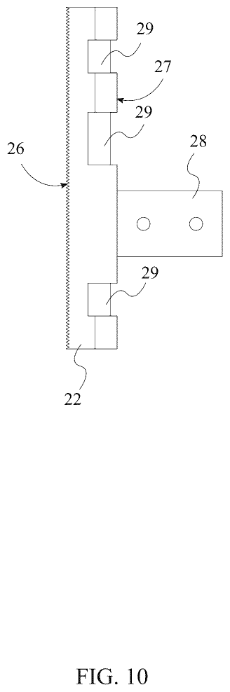

In reference to FIG. 1 through FIG. 17, the present invention is a light pole sign system with wind release capability. It is an aim of the present invention to provide an improved light pole sign system that is more durable, easier to install, and provides additional signage options to the customer.

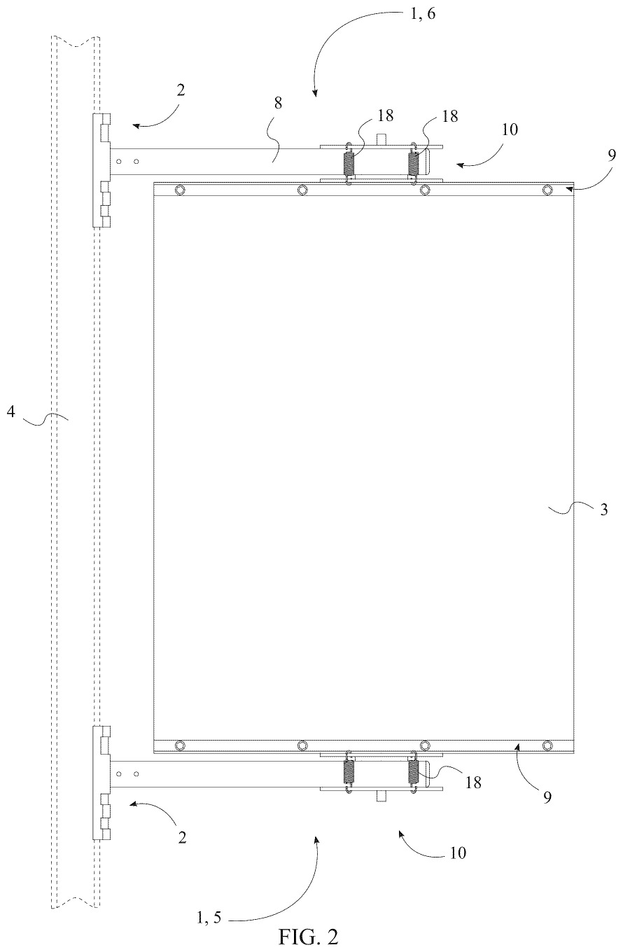

The following description is in reference to FIG. 1 through FIG. 17. According to a preferred embodiment, the present invention comprises a plurality of signage holders 1, a plurality of pole connectors 2, a sign board 3, and a pole 4. As seen in FIG. 1 and FIG. 2, the plurality of signage holders 1 includes a lower signage holder 5 and an upper signage holder 6. Further, the sign board 3 is mounted between the plurality of signage holders 1. More specifically, the plurality of signage holders 1 is spaced apart to fit the sign board 3 in between. Furthermore, each of the plurality of signage holders 1 is mounted to the pole 4 through a corresponding pole connector 7, wherein the corresponding pole connector 7 is from the plurality of pole connectors 2. The plurality of pole connectors 2 helps mount the signage holders 1 to the pole 4. In other words, each of the lower and upper signage holders 5,6, mount directly to a light pole with the help of the plurality of pole connectors 2. The pole 4 can have any shape, dimensions, cross section, material etc. that are known to one of ordinary skill in the art, as long as the intents of the present invention are not altered.

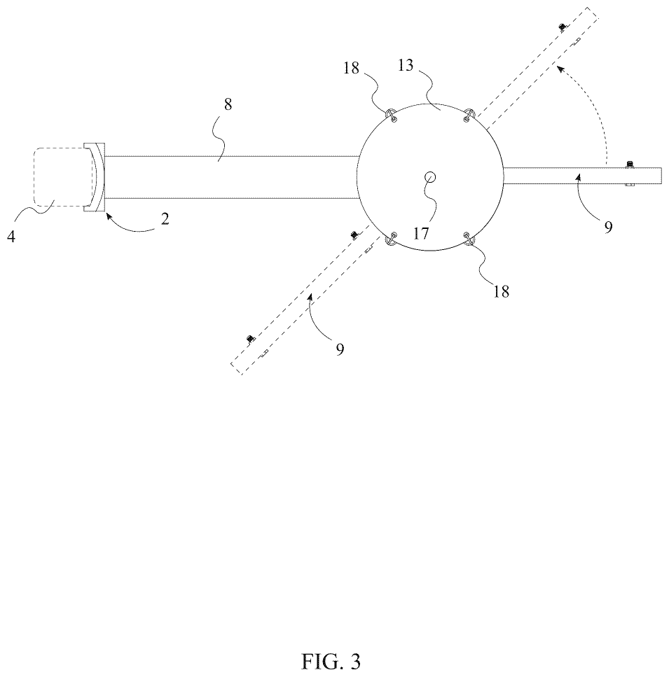

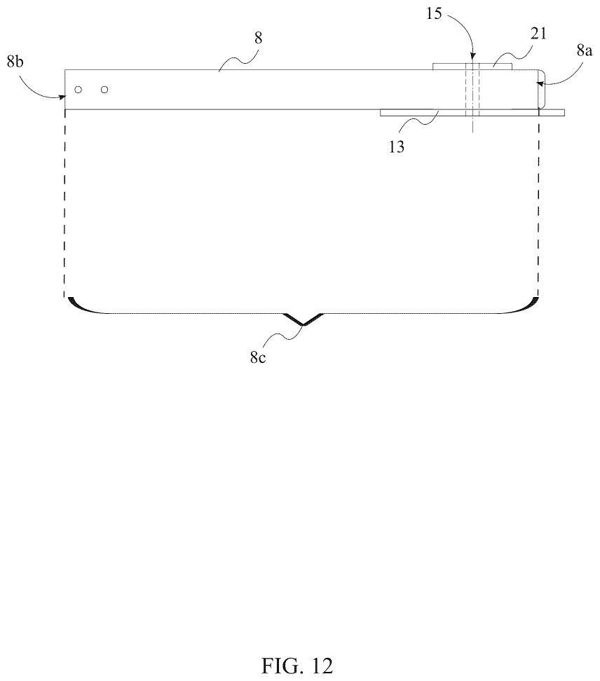

In the preferred embodiment, each of the plurality of signage holders 1 comprises a pole arm 8, a swivel arm 9, and a connecting member 10. The pole arm 8 is the main structural element that protrudes from the pole 4 and extends outwards. Preferably, the pole arm 8 is a rectangular cuboid, that is made of a sturdy material such as metal, is hollow inside, and is mounted normally to the pole 4. However, the pole arm 8 may comprise any other shape, length, cross section, material, etc., as long as the objective of the present invention is fulfilled. As seen in FIG. 12, the pole arm comprises a first end 8a and a second end 8b, wherein the first end 8a is positioned opposite to the second end 8b, across a length 8c of the pole arm 8. In other words, the first end 8a constitutes a terminal end of the pole arm 8 that is positioned away from the pole 4, and the second end 8b constitutes a terminal end of the pole arm 8 that is mounted adjacent to the pole 4. As seen in FIG. 1, the connecting member 10 is mounted between the pole arm 8 and the swivel arm 9. The swivel arm 9 is the segment that directly connects to a terminal edge of the sign board 3 and swivels in both directions as seen in FIG. 3. The connecting member 10 is a combination of elements that help connect the swivel arm 9 to the pole arm 8. Further, the connecting member 10 is mounted adjacent to the first end 8a of the pole arm 8.

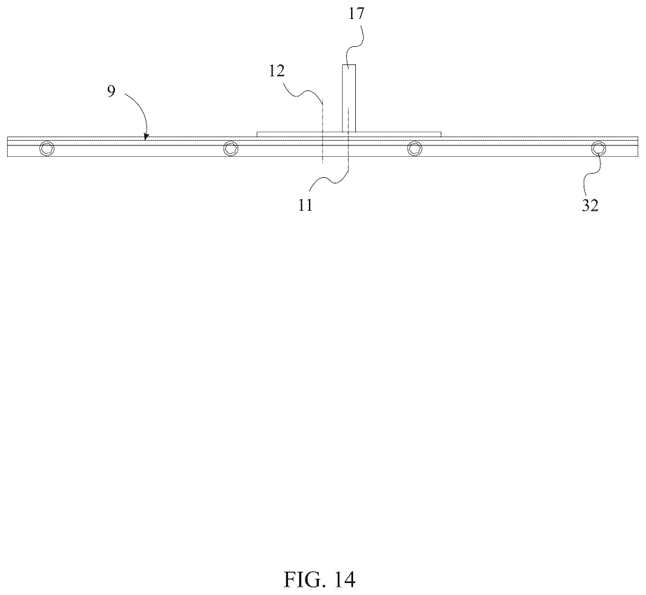

It is an aim of the present invention to enable wind release capability. To accomplish this, the swivel arm 9 is pivotably mounted along a center of the connecting member 10. Furthermore, as seen in FIG. 14, the swivel arm 9 is mounted to the pole arm 8 along an off-center pivot point 11, wherein the off-center pivot point 11 is laterally offset from a center 12 of the swivel arm 9. More specifically, when properly installed, both the upper signage holder 6 and the lower signage holder 5 enable the sign board 3 to pivot about the off-center pivot point 11, as seen in FIG. 3. This provides two major benefits. First, when the wind is blowing directly into the sign, it divides the wind pressure causing the sign board 3 to turn, thereby moving the wind pressure to the pivot point 11. Second, the off-center pivot point 11 eliminates the tendency for the sign board 3 to flutter in high winds. In particular, when a strong wind is coming directly at the outside leading edge of the sign at the rear (i.e., the edge closest to the light pole), the sign board 3 has a tendency to flutter. The flutter effect can be detrimental because it destroys the graphics, sign, banner and often the related hardware. By moving the pivot point so that the larger distance is on the rear side closest to the light pole, it allows the back side to act as a rudder to help move the front side of the sign board back to the center or resting position. Thus, the sign board 3 is operatively connected to the connecting member 10 through the swivel arm 9, wherein the connecting member 10 restores the sign board 3 and the swivel arm 9 to a resting position from a pivoted position.

A more detailed description of the present invention follows.

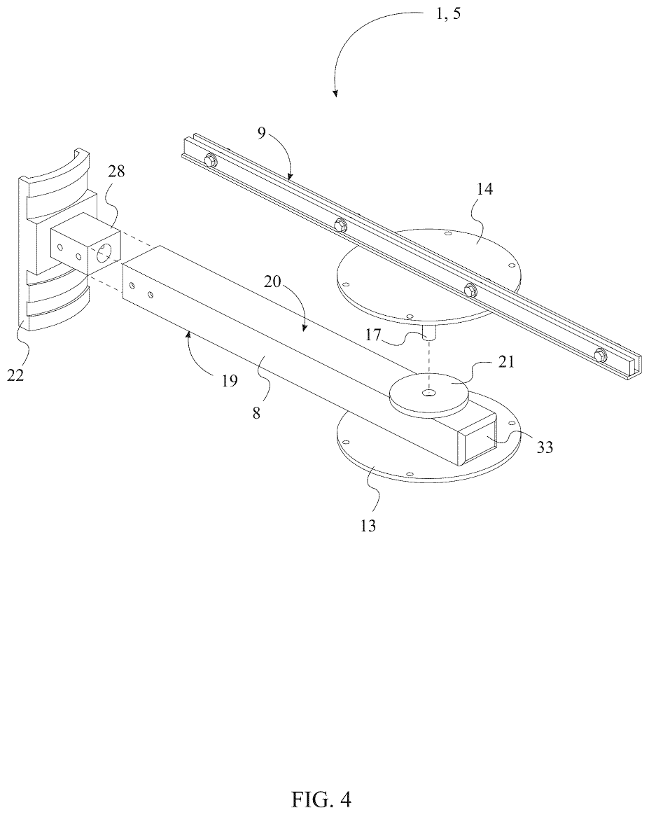

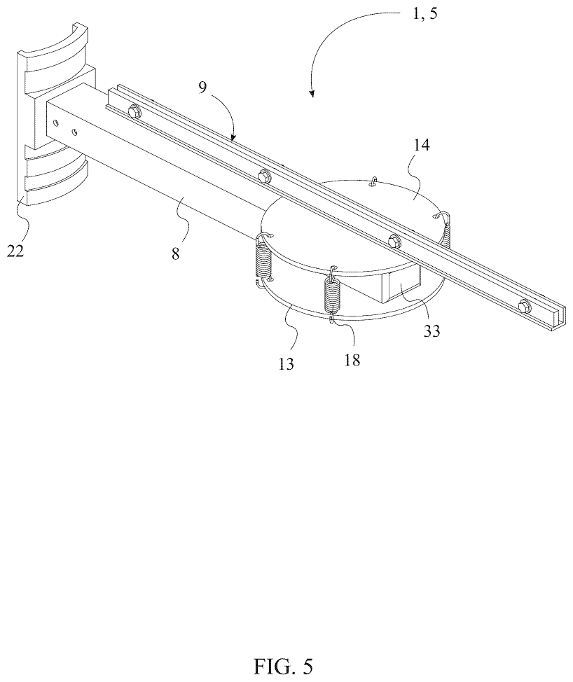

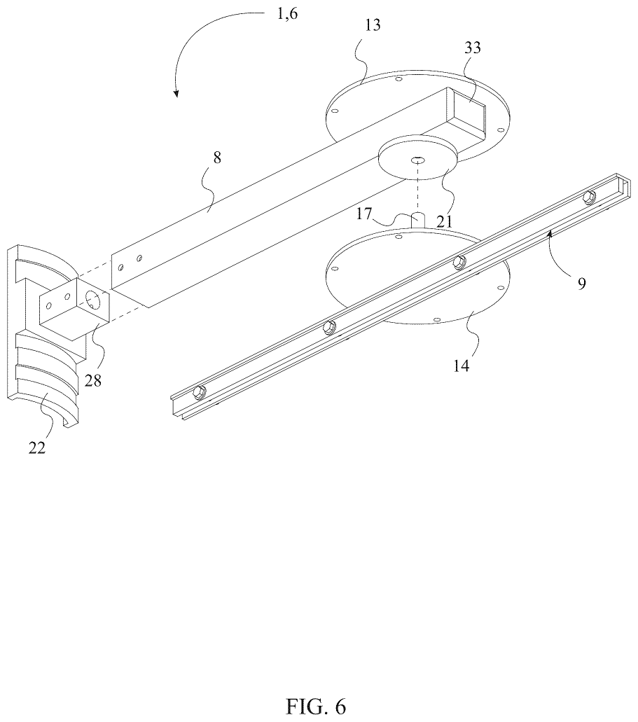

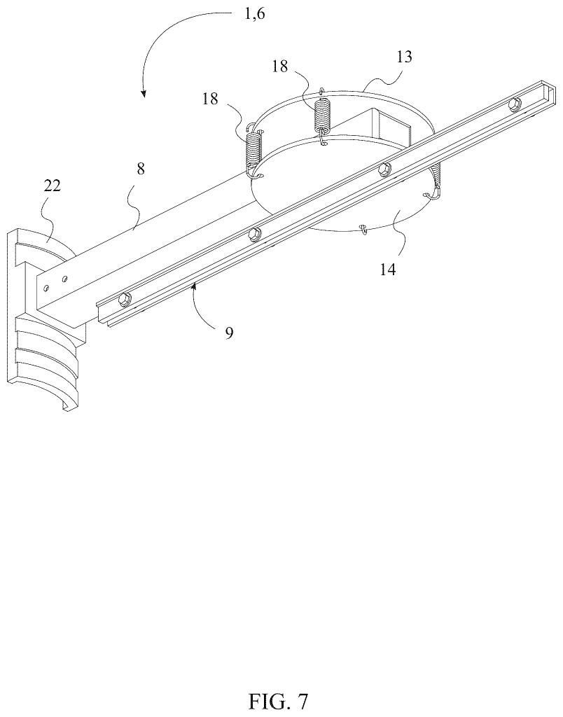

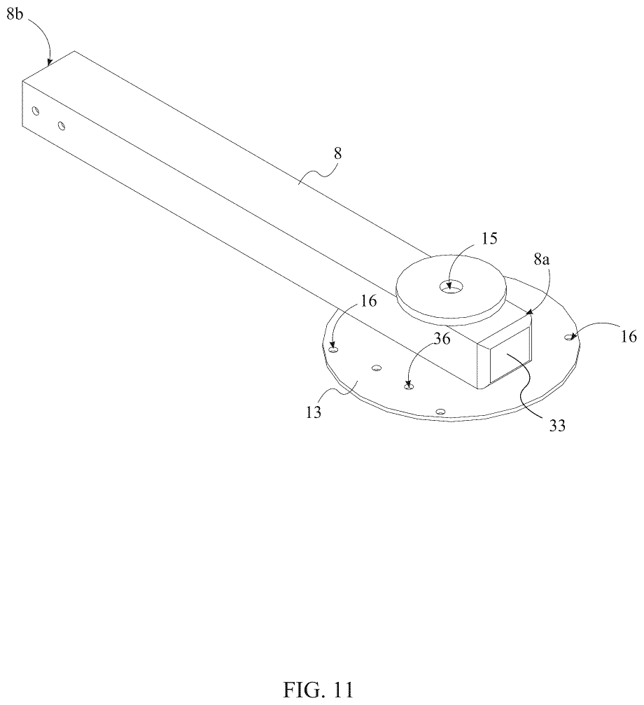

According to the preferred embodiment, the connecting member 10 comprises a fixed plate 13, a pivot plate 14, a connecting hole 15, a plurality of peripheral holes 16, a pivot post 17, and a plurality of springs 18. As seen in FIG. 4, the fixed plate 13 is mounted onto a first surface 19 of the pole arm 8, and the pivot plate 14 is mounted onto a second surface 20 of the pole arm 8, wherein the second surface 20 is positioned opposite to the first surface 19 across the pole arm 8. In reference to FIG. 4, the fixed plate 13 is mounted onto a bottom surface of the pole arm 8 and the pivot plate 14 is mounted onto an upper surface of the pole arm 8. In reference to FIG. 6, the fixed plate 13 is mounted onto an upper surface of the pole arm 8 and the pivot plate 14 is mounted onto a lower surface of the pole arm 8. This is so that the pivot plate 14 can also pivot or swivel with the sign board 3 and swivel arm 9, thereby enabling wind release capability. As seen in FIG. 11, the connecting hole 15 traverses centrally through the fixed plate 13, and the connecting hole 15 traverses through the pole arm 8 adjacent to the first end 8a of the pole arm 8. The connecting hole 15 helps connect different components of the connecting member 10 with the help of the pivot post 17. To that end, the pivot post 17 is centrally mounted onto the pivot plate 14, and the pivot post 17 is threaded through the connecting hole 15. Preferably, the pivot post 17 is a cylindrical post that is centrally mounted to the pivot plate 14 and locks the connecting member 10 to the pole arm 8. In other words, the fixed plate 13 is connected to the pivot plate 14 centrally through the pivot post 17. As clearly seen in FIG. 11, the plurality of peripheral holes 16 traverses through peripheral edges of the connecting member 10. More specifically, the plurality of peripheral holes 16 traverse along peripheral edges of the fixed plate 13 and the pivot plate 14 respectively. Further, as seen in FIG. 1, FIG. 2, FIG. 5, and FIG. 7, the plurality of springs 18 is threaded through the plurality of peripheral holes 16. This is so that the pivot plate 14 is rotatably and retractably connected to the fixed plate 13 through the plurality of springs 18. In other words, the springs enable the swivel arms to rotate when force is applied on either end. When force is removed, the springs return the lower swivel arm back to its resting position. More specifically, the plurality of springs 18 are used to keep the sign board 3 in its resting position. When the wind kicks up, the springs and off-center pivot point 11 are designed to turn the sign board 3 enough to release the wind pressure exerted on the sign and continue to do so until the pressure subsides. Once the wind subsides, the spring tension returns the sign board 3 back to its original resting position.

Continuing with the preferred embodiment, and as seen in FIG. 4, FIG. 6, FIG. 11, and FIG. 12, the present invention comprises a washer plate 21. Preferably, the washer plate 21 is connected between the pivot plate 14 and the pole arm 8 through the pivot post 17, and the washer plate 21 is concentrically positioned with respect to the fixed plate 13 and the pivot plate 14. The washer plate 21 functions as a mounting surface for the swivel arms 7 to rest upon and swivel.

To secure the pole arm 8 to the pole 4, each of the pole connectors 2 comprises a pole bracket 22, and a plurality of pole fasteners 23. Preferably, the pole bracket 22 is mounted onto the pole 4, and the plurality of pole fasteners 23 is integrated between the pole bracket 22 and the pole 4. As seen in FIG. 1, preferably, the plurality of pole fasteners 23 comprises at least one of a plurality of hose clamps 24 and a ratchet strap 25. This is so that, multiple hose clamps may be tightened around the pole bracket 22 to lock the pole bracket 22 in place, and the ratchet strap 25 acts as a safety strap and does not let the sign board 3 fall, in an event the hose clamps 24 break.

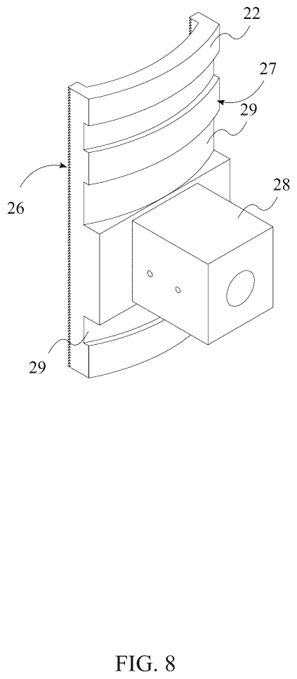

In reference to FIGS. 8-10, the pole bracket 22 further comprises a pole facing surface 26, a sign facing surface 27, a pole arm connector plug 28, and a plurality of grooves 29. Preferably, the pole facing surface 26 is positioned opposite to the sign facing surface 27 across the pole bracket 22. More specifically, the pole facing surface 26 comprises a jaw opening, that traverses longitudinally and comprises a pair of arms on each side a and a recessed portion in the center. In this arrangement, the jaw opening is capable of attaching to different size light poles. Further, the pole arm connector plug 28 is mounted onto the sign facing surface 27 in such a way that the pole arm connector plug 28 extends away from the pole facing surface 26. Preferably, the pole arm connector plug 28 traverses centrally into the hollow pole arm 8, through the second end 8b of the pole arm 8 and interlocks with the pole arm 8. This enables the user to secure the pole arm 8 to the pole bracket 22 with hardware. It should be noted that any other fasteners or fastening mechanisms that are used to connect or fasten different parts of the present invention, examples of which include, but are not limited to nuts, screws, nails, magnetic fasteners, clips, rivets, etc. fall under the limits of the present invention. Furthermore, as seen in FIG. 1, and FIG. 8, the plurality of grooves 29 is distributed along the sign facing surface 27 such that the plurality of pole fasteners 23 may be tightened around each of the plurality of grooves 29.

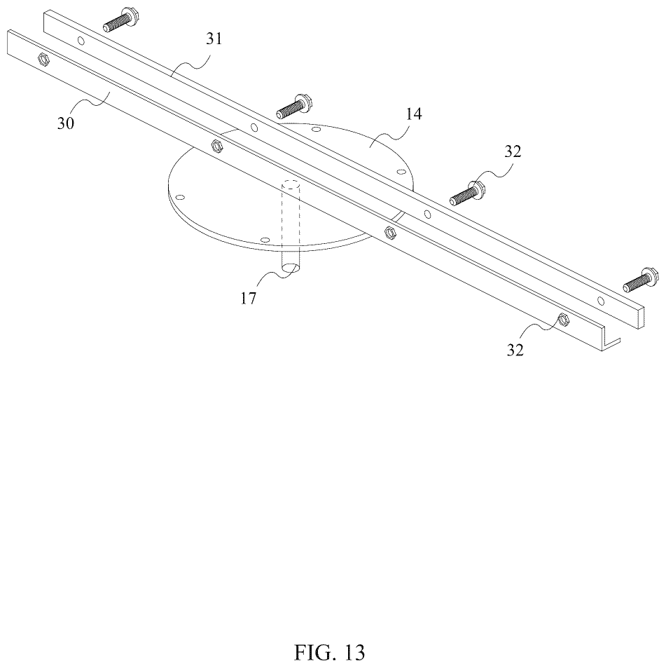

In reference to FIGS. 13, each of the swivel arms 9 further comprises an angle sign connector 30, a flat sign connector 31, and a plurality of swivel arm fasteners 32. Preferably, the plurality of swivel arm fasteners 32 is integrated between the angle sign connector 30 and the flat sign connector 31. The angle sign connector 30 extends outward to a predefined length defined by the width of the sign board 3. As seen in FIGS. 13, the pivot plate 14 and the pivot post 17 extend downward from the bottom surface of the angle sign connector 30 on the lower swivel arm, positioned at a predefined distance away from the nearest edge. Conversely, as seen in FIGS. 14, the pivot plate 14 and the pivot post 17 extend upward from the top surface of the angle sign connector 30 on the upper swivel arm, positioned at a predefined distance away from the nearest edge. As previously mentioned, the off-center mounting position of the pivot post 17 helps maintain stability and prevent buffeting of the sign board 3 during high wind conditions. Each of the rotating pivot plates 14 is identical in shape and size to the fixed round plate 13 on the pole arms 8. The rotating pivot plate 14 is terminally connected to the fixed plate 13 and angle sign connector 30. Specifically, the pivot plate 14 is inserted into the pivot post 17 and welded to the corresponding angle sign connector 30. The plurality of peripheral holes 16 on both the pivot plate 14 and fixed round plate 14 are aligned to allow for proper installation of the springs 18. However, it should be noted that, any other method of fastening other than welding, that is known to one of ordinary skill in the art, will also fall under the limits of the present invention.

Continuing with the preferred embodiment, the flat sign connector 31 is opposingly aligned with the angle sign connector 30 and is used to attach the sign board 3. Specifically, the plurality of swivel arm fasteners 32 is distributed longitudinally across both the angle sign connector 30 and the flat sign connector 31. in other words, the sign board 3 is positioned between the angle sign connector 30 and the flat sign connector 31 and secured in place using hardware. Preferably, the plurality of swivel sign fasteners 32 comprises screws and nuts, wherein the screws are inserted through each of the apertures and secured to nuts that are welded to the backside of the angle sign connector 30. In this arrangement, the angle sign connector 30, flat sign connector 31, and fasteners function together as a clamp, thereby securing the top and bottom edges of the sign board 3 to the upper and lower swivel arms 9, respectively. In other words, terminal edges of the sign board 3 are positioned between the angle sign connector 30 and the flat sign connector 31 as seen in FIG. 1 and FIG. 2.

As seen in FIG. 11, the present invention comprises an end cap 33, wherein the end cap 33 is mounted onto the first end 8a of the pole arm 8. The end cap 33 is removably attached to the distal end of the pole arm 8, opposite the pole arm connector plug 28. Preferably, the pole arm 8 is hollow, and the pole arm connector plug 28 extends into the hollow second end 8b of the pole arm 8. In this arrangement, the end cap 33 functions as a cover to seal off the open first end of the pole bar 8.

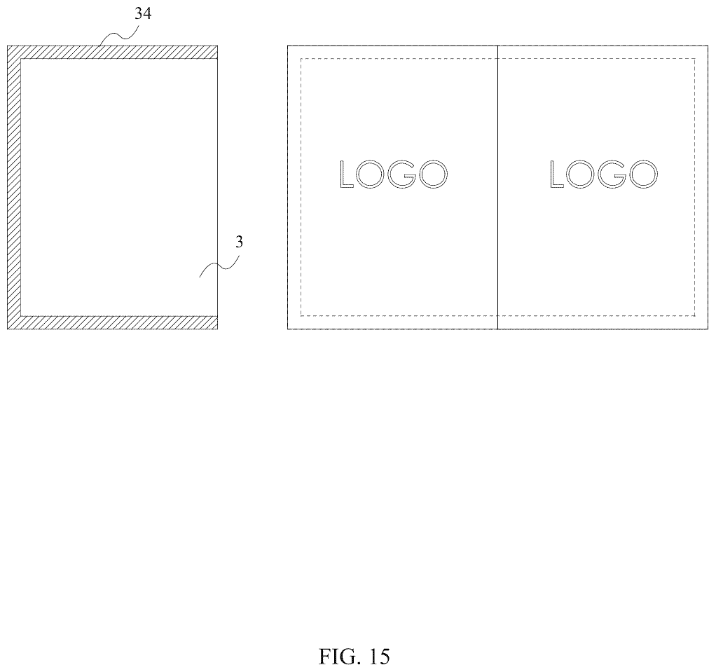

According to the preferred embodiment, sign board installation may be carried out in multiple ways, depending on design, user, and/or manufacturing requirements. To that end, the present invention comprises a plurality of sign board fasteners 34. Preferably, the plurality of sign board fasteners 34 is integrated between the sign board 3 and the plurality of swivel arms 7. In the preferred embodiment, as seen in FIG. 15, the sign can be installed to the sign board 3 using hook and loop fasteners (e.g., Velcro). In this embodiment, the sign can be a printed vinyl or fabric banner. The sign is equal in height to the sign board, but twice as wide. This allows the sign to be wrapped around the sign board 3, making it visible on both sides. Hook and loop strips are sewn around the outer edges on the interior side of the sign. Similarly, corresponding hook and loop strips are applied to the sign board 3 as well. In particular, adhesive hook and loop strips are applied to all edges of the sign board, front and back, except the two outside edges. In this arrangement, the sign wraps around the sign board 3 and is secured in place with the hook and loop strips. This process eliminates pockets of air getting behind the sign and potentially damaging them.

In a first alternate embodiment, the sign can be installed to the sign board in two separate pieces. In this configuration, the sign comprises two thin plastic boards that are identical in shape and cut to fit the sign board. One sign is placed over the front of the sign board. The second sign is placed over the back of the sign board. The two signs are secured to the sign board during installation. Specifically, the bolts on the upper and lower swivel arms are loosened and the two signs are inserted with the sign board in between. Once properly positioned, the bolts on the swivel arms are retightened, thereby securing the two signs to the sign board.

In a second alternate embodiment, the graphic is integrated directly into the sign board 3. Specifically, an aluminum sign board is die-cut or routed in the shape of the graphic, providing a dimensional or 3D look. Alternatively, the die-cut graphic can be applied to plastic boards. In this arrangement, the two plastic boards are fastened together or sandwiched on the original sign board.

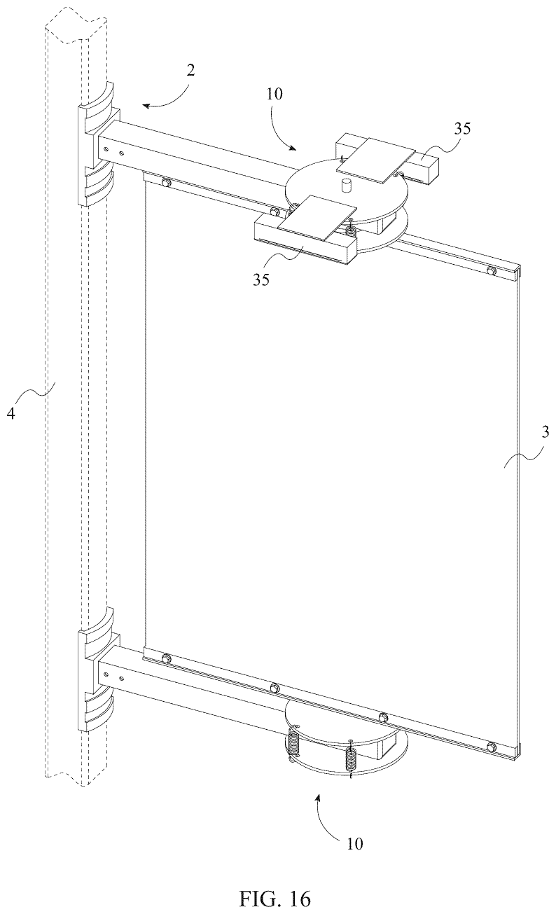

In a third alternate embodiment, as seen in FIG. 16, the present invention comprises a plurality of illuminating devices 35, wherein the plurality of illuminating devices 35 is integrated onto the connecting member 10. More specifically, the plurality of illuminating device 35 may be a pair of solar LED lights can be installed with the help of two mounting brackets, that may be fastened to the top surface of the fixed round plate 13, each extending outward in the direction of the sign board 3. To that end, the fixed plate 13 on the upper signage member 6 comprises a plurality of apertures 36, as seen in FIG. 11. A solar-powered LED light is secured to the distal end on each of the mounting brackets. In this arrangement, the LED lights are angled to provide sufficient lighting to both sides of the sign board 3. In other words, the plurality of illuminating devices 35 is oriented towards the sign board 3.

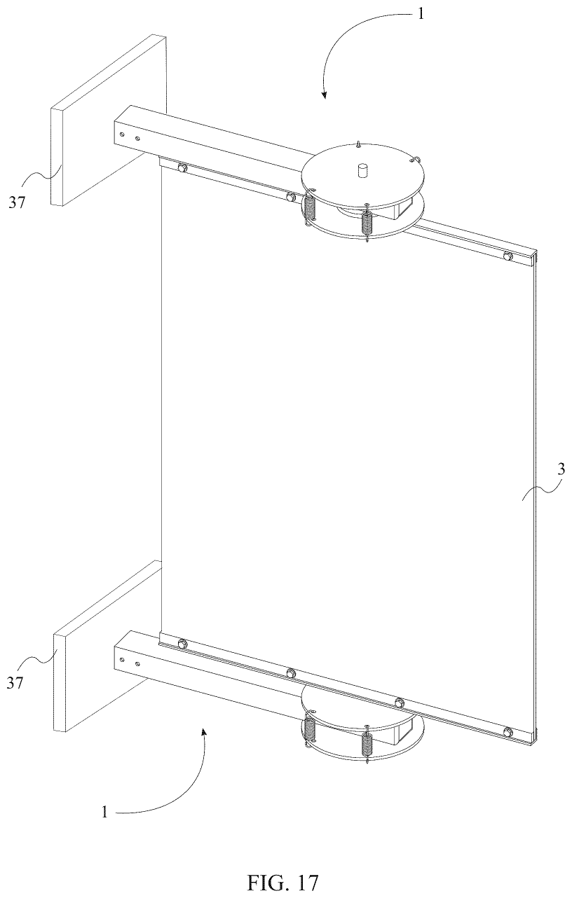

In a fourth alternate embodiment, and as seen in FIG. 17, the present invention comprises a plurality of wall mounting plates 37, wherein the plurality of wall mounting plates 37 is terminally connected to the plurality of signage holders 1. In this embodiment, each of the plurality of wall mounting plates 36 is integrated between a wall and the plurality of signage holders 1.

Although the invention has been explained in relation to its preferred embodiment, it is to be understood that many other possible modifications and variations can be made without departing from the spirit and scope of the invention as hereinafter claimed.

What is claimed is:

1. A light pole sign holing system, comprising:
a plurality of signage holders;
a plurality of pole connectors;
a sign board;
a pole;
each of the plurality of signage holders comprising a pole arm, a swivel arm, and a connecting member;
the pole arm comprising a first end and a second end, wherein the first end is positioned opposite to the second end, across a length of the pole arm;
the sign board being mounted between the plurality of signage holders;
each of the plurality of signage holders being mounted to the pole through a corresponding pole connector, wherein the corresponding pole connector is from the plurality of pole connectors;
the connecting member being mounted between the pole arm and the swivel arm;
the connecting member being mounted adjacent to the first end of the pole arm;
the swivel arm being pivotably mounted along a center of the connecting member;
the swivel arm being mounted to the pole arm along an off-center pivot point, wherein the off-center pivot point is laterally offset from the center of the swivel arm; and
the sign board being operatively connected to the connecting member through the swivel arm, wherein the connecting member restores the sign board and the swivel arm to a resting position from a pivoted position.

2. The light pole sign holding system of claim 1, the connecting member comprising:
a fixed plate, a pivot plate, a connecting hole, a plurality of peripheral holes, a pivot post, and a plurality of springs;
the fixed plate being mounted onto a first surface of the pole arm;
the pivot plate mounted onto a second surface of the pole arm, wherein the second surface is positioned opposite to the first surface across the pole arm;
the fixed plate connected to the pivot plate centrally through the pivot post;
the connecting hole traversing centrally through the fixed plate;
the connecting hole traversing through the pole arm adjacent to the first end of the pole arm;
the pivot post being centrally mounted onto the pivot plate;
the pivot post being threaded through the connecting hole;
the plurality of peripheral holes traversing through the fixed plate and the pivot plate along peripheral edges of the fixed plate and the pivot plate;
the plurality of springs being threaded through the plurality of peripheral holes; and
the pivot plate being rotatably and retractably connected to the fixed plate through the plurality of springs.

3. The light pole sign holding system of claim 2, comprising:
a washer plate;
the washer plate being connected between pivot plate and pole arm through the pivot post; and
the washer plate being concentrically positioned with respect to the fixed plate and the pivot plate.

4. The light pole sign holding system of claim 1, each of the pole connectors comprising:
a pole bracket;
a plurality of pole fasteners;
the pole bracket being mounted onto the pole; and
the plurality of pole fasteners being integrated between the pole bracket and the pole.

5. The light pole sign holding system of claim 4, wherein the plurality of pole fasteners comprises at least one of a plurality of hose clamps and a ratchet strap.

6. The light pole sign holding system of claim 4, the pole bracket comprising:
a pole facing surface;
a sign facing surface;
a pole arm connector plug;
a plurality of grooves;
the pole facing surface being positioned opposite to the sign facing surface across the pole bracket;
the pole arm connector plug being mounted onto the sign facing surface;
the pole arm connector plug extending away from the pole facing surface;
the pole arm connector traversing centrally into the pole arm, through the second end of the pole arm; and
the plurality of grooves being distributed along the sign facing surface.

7. The light pole sign holding system of claim 1, the swivel arm comprising:
an angle sign connector;
a flat sign connector;
a plurality of swivel arm fasteners;
the plurality of swivel arm fasteners being integrated between the angle sign connector and the flat sign connector; and
a terminal edge of the sign board being positioned between the angle sign connector and the flat sign connector.

8. The light pole sign holding system of claim 7, wherein the plurality of swivel arm fasteners are nuts and bolts.

9. The light pole sign holding system of claim 1, comprising:
an end cap; and
the end cap being mounted onto the first end of the pole arm.

10. The light pole sign holding system of claim 1, comprising:
a plurality of sign board fasteners; and
the plurality of sign board fasteners being integrated between the sign board and the plurality of swivel arms.

11. The light pole sign holding system of claim 1, comprising:
a plurality of illuminating devices;
the plurality of illuminating devices being integrated onto the connecting member; and
the plurality of illuminating devices being oriented towards the sign board.

12. The light pole sign holding system of claim 1, comprising:
a plurality of wall mounting plates;
the plurality of wall mounting plates being terminally connected to the plurality of signage holders; and
the plurality of wall mounting plates being integrated between a wall and the plurality of signage holders.

13. A light pole sign holing system, comprising:
a plurality of signage holders;
a plurality of pole connectors;
a sign board;
a pole;
each of the plurality of signage holders comprising a pole arm, a swivel arm, and a connecting member;
the pole arm comprising a first end and a second end, wherein the first end is positioned opposite to the second end, across a length of the pole arm;
the connecting member comprising a fixed plate, a pivot plate, a connecting hole, a plurality of peripheral holes, a pivot post, and a plurality of springs;
the sign board being mounted between the plurality of signage holders;
each of the plurality of signage holders being mounted to the pole through a corresponding pole connector, wherein the corresponding pole connector is from the plurality of pole connectors;
the connecting member being mounted between the pole arm and the swivel arm;
the connecting member being mounted adjacent to the first end of the pole arm;
the swivel arm being pivotably mounted along a center of the connecting member;
the fixed plate being mounted onto a first surface of the pole arm;
the pivot plate mounted onto a second surface of the pole arm, wherein the second surface is positioned opposite to the first surface across the pole arm;
the fixed plate connected to the pivot plate centrally through the pivot post;
the connecting hole traversing centrally through the fixed plate;
the connecting hole traversing through the pole arm adjacent to the first end of the pole arm;
the pivot post being centrally mounted onto the pivot plate;
the pivot post being threaded through the connecting hole;
the plurality of peripheral holes traversing through the fixed plate and the pivot plate along peripheral edges of the fixed plate and the pivot plate;
the plurality of springs being threaded through the plurality of peripheral holes;
the pivot plate being rotatably and retractably connected to the fixed plate through the plurality of springs;
the swivel arm being mounted to the pole arm along an off-center pivot point, wherein the off-center pivot point is laterally offset from the center of the swivel arm; and
the sign board being operatively connected to the connecting member through the swivel arm, wherein the connecting member restores the sign board and the swivel arm to a resting position from a pivoted position.

14. The light pole sign holding system of claim 13, comprising:
a washer plate;
the washer plate being connected between pivot plate and pole arm through the pivot post; and
the washer plate being concentrically positioned with respect to the fixed plate and the pivot plate.

15. The light pole sign holding system of claim 13, each of the pole connectors comprising:
a pole bracket;
a plurality of pole fasteners;
the pole bracket being mounted onto the pole; and
the plurality of pole fasteners being integrated between the pole bracket and the pole.

16. The light pole sign holding system of claim 15, wherein the plurality of pole fasteners comprises at least one of a plurality of hose clamps and a ratchet strap.

17. The light pole sign holding system of claim 15, the pole bracket comprising:
a pole facing surface;
a sign facing surface;
a pole arm connector plug;
a plurality of grooves;
the pole facing surface being positioned opposite to the sign facing surface across the pole bracket;
the pole arm connector plug being mounted onto the sign facing surface;
the pole arm connector plug extending away from the pole facing surface;
the pole arm connector traversing centrally into the pole arm, through the second end of the pole arm; and
the plurality of grooves being distributed along the sign facing surface.

18. The light pole sign holding system of claim 13, the swivel arm comprising:
an angle sign connector;
a flat sign connector;
a plurality of swivel arm fasteners;
the plurality of swivel arm fasteners being integrated between the angle sign connector and the flat sign connector; and
a terminal edge of the sign board being positioned between the angle sign connector and the flat sign connector.

19. The light pole sign holding system of claim 13, comprising:
a plurality of sign board fasteners; and
the plurality of sign board fasteners being integrated between the sign board and the plurality of swivel arms.

20. The light pole sign holding system of claim 13, comprising:
a plurality of illuminating devices;
the plurality of illuminating devices being integrated onto the connecting member; and
the plurality of illuminating devices being oriented towards the sign board.
